(19) United States
(12) Patent Application Publication
(10) Pub. No.: US 2024/0163776 A1
(43) Pub. Date: May 16, 2024

(54) APPARATUS, SYSTEM, AND METHOD OF A SENSING MEASUREMENT EXCHANGE

(71) Applicants: Cheng Chen, Camas, WA (US); Dibakar Das, Hillsboro, OR (US); Carlos Cordeiro, Camas, WA (US)

(72) Inventors: Cheng Chen, Camas, WA (US); Dibakar Das, Hillsboro, OR (US); Carlos Cordeiro, Camas, WA (US)

(21) Appl. No.: 18/399,233

(22) Filed: Dec. 28, 2023

(51) Int. Cl. H04W 48/16; H04W 74/06

(52) U.S. Cl. CPC H04W 48/16; H04W 74/06; H04W 84/12

(57) ABSTRACT

For example, an Access Point (AP) may be configured to identify a Trigger-Based (TB) sensing measurement exchange of a Wireless Local Area Network (WLAN) sensing procedure to be initiated by the AP. For example, the AP may be configured to determine that a non-AP Multi-Link Device (MLD) at an Enhanced Multi-Link Single Radio (EMLSR) operation mode is to participate as a sensing responder of the TB sensing measurement exchange. For example, the AP may be configured to transmit an Initial Control Frame (ICF) addressed to the non-AP MLD prior to initiating the TB sensing measurement exchange, for example, based on the determination that the non-AP MLD at the EMLSR operation mode is to participate as a sensing responder of the TB sensing measurement exchange.

### BACKGROUND

Wireless sensing is a term given to a usage of wireless technology to perform radar-like applications. For example, wireless sensing may be used to detect motion in a room, for example, to detect when a person approaches a target device.

The wireless sensing may be implemented by a wireless communication device, which is capable to communicate wireless signals, for example, to detect changes in an environment where the wireless signals propagate.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a multi-link communication scheme, which may be implemented in accordance with some demonstrative aspects.

FIG. 3 is a schematic illustration of a multi-link communication scheme, which may be implemented in accordance with some demonstrative aspects.

FIG. 4 is a schematic illustration of a Trigger Based (TB) sensing measurement exchange, which may be implemented in accordance with some demonstrative aspects.

FIG. 5 is a schematic flow-chart illustration of a method of a sensing measurement exchange, in accordance with some demonstrative aspects.

FIG. 6 a schematic flow-chart illustration of a method of a sensing measurement exchange, in accordance with some demonstrative aspects.

FIG. 7 is a schematic flow-chart illustration of a method of a sensing measurement exchange, in accordance with some demonstrative aspects.

FIG. 8 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); IEEE 802.11be (IEEE P802.11be/D4.0 Draft Standard for Information technology—Telecommunications and information exchange between systems Local and metropolitan area networks— Specific requirements; Part 11: Wireless LAN Medium Access Control (MAC) and Physical Layer (PHY) Specifications; Amendment 8: Enhancements for extremely high throughput (EHT), July 2023); and/or IEEE 802.11bf (IEEE P802.11bf/D2.1 Draft Standard for Information technology—Telecommunications and information exchange between systems Local and metropolitan area networks— Specific requirements; Part 11: Wireless LAN Medium Access Control (MAC) and Physical Layer (PHY) Specifications; Amendment 2: Enhancements for Wireless LAN Sensing, September 2023)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

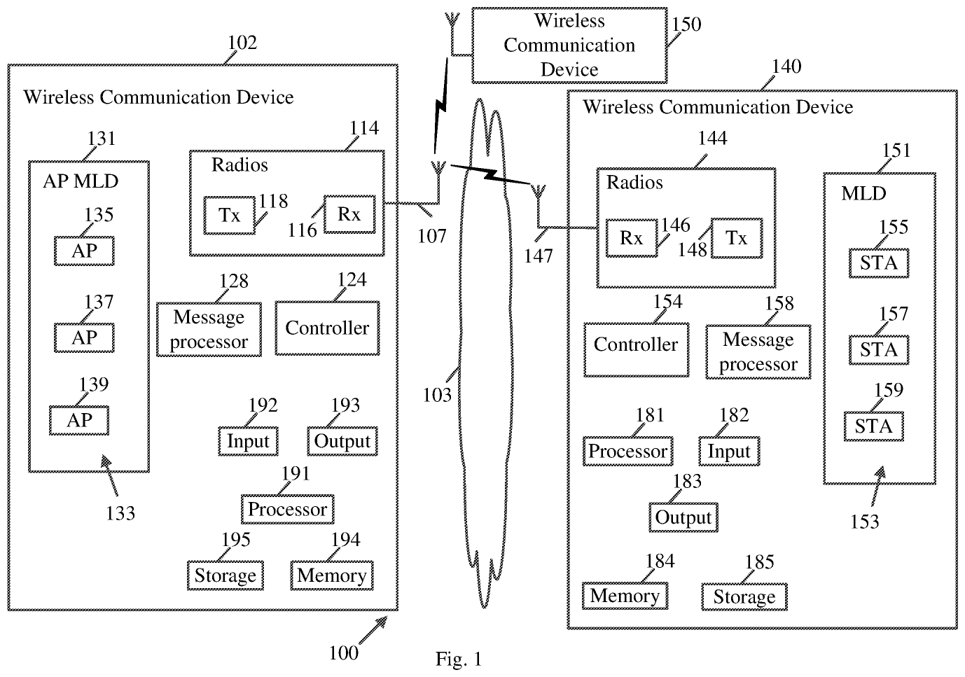

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 150, and/or one or more other devices.

In some demonstrative aspects, devices 102, 140, and/or 150 may include a mobile device or a non-mobile, e.g., a static, device.

For example, devices 102, 140, and/or 150 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 150 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternative include one or more channels in an mmWave wireless communication frequency band.

In other aspects, WM 103 may include any other type of channel over any other frequency band.

In some demonstrative aspects, device 102, device 140, and/or device 150 may include one or more radios including circuitry and/or logic to perform wireless communication between devices 102, 140, 150 and/or one or more other wireless communication devices. For example, device 102 may include one or more radios 114, and/or device 140 may include one or more radios 144.

In some demonstrative aspects, radios 114 and/or 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an S1G band, and/or any other band.

In some demonstrative aspects, radios 114 and/or 144 may include, or may be associated with one or more antennas.

In some demonstrative aspects, device 102 may include one or more antennas 107, and/or device 140 may include one or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 150 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 150 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or the one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 150 may include, operate as, perform the role of, and/or perform one or more functionalities of, one or more STAs. For example, device 102 may include at least one STA, device 140 may include at least one STA, and/or device 150 may include at least one STA.

In some demonstrative aspects, device 102, device 140, and/or device 150 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 150 may be configured to perform one or more operations, and/or functionalities of a WiFi 8 STA.

In other aspects, for example, devices 102, 140 and/or 150 may be configured to perform one or more operations, and/or functionalities of an Ultra High Reliability (UHR) STA.

In other aspects, for example, devices 102, 140 and/or 150 may be configured to perform one or more operations, and/or functionalities of any other additional or alternative type of STA.

In other aspects, device 102, device 140 and/or device 150 may include, operate as, perform the role of, and/or perform one or more functionalities of, any other wireless device and/or station, e.g., a WLAN STA, a WiFi STA, and the like.

In some demonstrative aspects, device 102, device 140 and/or device 150 may be configured operate as, perform the role of, and/or perform one or more functionalities of, an access point (AP), e.g., an EHT AP STA and/or a UHR AP STA.

In some demonstrative aspects, device 102, device 140 and/or device 150 may be configured to operate as, perform the role of, and/or perform one or more functionalities of, a non-AP STA, e.g., an EHT non-AP STA and/or a UHR non-AP STA.

In other aspects, device 102, device 140 and/or device 150 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140 and/or 150 may be configured to communicate in an EHT network, a UHR network, and/or any other network.

In some demonstrative aspects, devices 102, 140 and/or 150 may be configured to operate in accordance with one or more Specifications, for example, including one or more IEEE 802.11 Specifications, e.g., an IEEE 802.11-2020 Specification, an IEEE 802.11be Specification, and/or any other specification and/or protocol.

In some demonstrative aspects, device 102, device 140 and/or device 150 may include, operate as, perform a role of, and/or perform the functionality of, one or more multi-link logical entities, e.g., as described below.

In other aspect, device 102, device 140 and/or device 150 may include, operate as, perform a role of, and/or perform the functionality of, any other entities, e.g., which are not multi-link logical entities.

For example, a multi-link logical entity may include a logical entity that contains one or more STAs. The logical entity may have one MAC data service interface and primitives to the logical link control (LLC) and a single address associated with the interface, which can be used to communicate on a distribution system medium (DSM). For example, the DSM may include a medium or set of media used by a distribution system (DS) for communications between APs, mesh gates, and the portal of an extended service set (ESS). For example, the DS may include a system used to interconnect a set of basic service sets (BSSs) and integrated local area networks (LANs) to create an extended service set (ESS). In one example, a multi-link logical entity may allow STAs within the multi-link logical entity to have the same MAC address. The multi-link entity may perform any other additional or alternative functionality.

In some demonstrative aspects, device 102, device 140 and/or device 150 may include, operate as, perform a role of, and/or perform the functionality of, a Multi-Link Device (MLD). For example, device 102 may include, operate as, perform a role of, and/or perform the functionality of, at least one MLD, and/or device 140 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140 and/or device 150 may be configured to operate as, perform the role of, and/or perform one or more functionalities of, an AP MLD.

In some demonstrative aspects, device 102, device 140 and/or device 150 may be configured to operate as, perform the role of, and/or perform one or more functionalities of, a non-AP MLD.

In other aspects, device 102, device 140 and/or device 150 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In one example, a multi-link infrastructure framework may be configured as an extension from a one link operation between two STAs, e.g., an AP and a non—AP STA.

In some demonstrative aspects, controller 124 may be configured to cause, trigger, instruct and/or control device 102 to operate as, perform a role of, and/or perform one or more operations and/or functionalities of, an AP MLD 131 including a plurality of AP STAs 133, e.g., including an AP STA 135, an AP STA 137 and/or an AP STA 139. In some aspects, as shown in FIG. 1, AP MLD 131 may include three AP STAs. In other aspects, AP MLD 131 may include any other number of AP STAs.

In one example, AP STA 135, AP STA 137 and/or AP STA 139 may operate as, perform a role of, and/or perform one or more operations and/or functionalities of, an EHT AP STA. In other aspects, AP STA 135, AP STA 137 and/or AP STA 139 may perform any other additional or alternative functionality.

In some demonstrative aspects, for example, the one or more radios 114 may include, for example, a radio for communication by AP STA 135 over a first wireless communication frequency channel and/or frequency band, e.g., a 2.4 GHz band, as described below.

In some demonstrative aspects, for example, the one or more radios 114 may include, for example, a radio for communication by AP STA 137 over a second wireless communication frequency channel and/or frequency band, e.g., a 5 GHz band, as described below.

In some demonstrative aspects, for example, the one or more radios 114 may include, for example, a radio for communication by AP STA 139 over a third wireless communication frequency channel and/or frequency band, e.g., a 6 GHz band, as described below.

In some demonstrative aspects, the radios 114 utilized by APs 133 may be implemented as separate radios. In other aspects, the radios 114 utilized by APs 133 may be implemented by one or more shared and/or common radios and/or radio components.

In other aspects, controller 124 may be configured to cause, trigger, instruct and/or control device 102 to operate as, perform a role of, and/or perform one or more operations and/or functionalities of, any other additional or alternative entity and/or STA, e.g., a single STA, multiple STAs, and/or a non-MLD entity.

In some demonstrative aspects, controller 154 may be configured to cause, trigger, instruct and/or control device 140 to operate as, perform a role of, and/or perform one or more operations and/or functionalities of, an MLD 151 including a plurality of STAs 153, e.g., including a STA 155, a STA 157 and/or a STA 159. In some aspects, as shown in FIG. 1, MLD 151 may include three STAs. In other aspects, MLD 151 may include any other number of STAs.

In one example, STA 155, STA 157 and/or STA 159 may operate as, perform a role of, and/or perform one or more operations and/or functionalities of, an EHT STA. In other aspects, STA 155, STA 157 and/or STA 159 may perform any other additional or alternative functionality.

In some demonstrative aspects, for example, the one or more radios 144 may include, for example, a radio for communication by STA 155 over a first wireless communication frequency channel and/or frequency band, e.g., a 2.4 GHz band, as described below.

In some demonstrative aspects, for example, the one or more radios 144 may include, for example, a radio for communication by STA 157 over a second wireless communication frequency channel and/or frequency band, e.g., a 5 GHz band, as described below.

In some demonstrative aspects, for example, the one or more radios 144 may include, for example, a radio for communication by STA 159 over a third wireless communication frequency channel and/or frequency band, e.g., a 6 GHz band, as described below.

In some demonstrative aspects, the radios 144 utilized by STAs 153 may be implemented as separate radios. In other aspects, the radios 144 utilized by STAs 153 may be implemented by one or more shared and/or common radios and/or radio components.

In some demonstrative aspects, controller 154 may be configured to cause, trigger, instruct and/or control MLD 151 to operate as, perform a role of, and/or perform one or more operations and/or functionalities of, a non-AP MLD. For example, STA 155, STA 157 and/or STA 159 may operate as, perform a role of, and/or perform one or more operations and/or functionalities of, a non-AP EHT STA.

In some demonstrative aspects, controller 154 may be configured to cause, trigger, instruct and/or control MLD 151 to operate as, perform a role of, and/or perform one or more operations and/or functionalities of, an AP MLD. For example, STA 155, STA 157 and/or STA 159 may operate as, perform a role of, and/or perform one or more operations and/or functionalities of, an AP EHT STA.

In other aspects controller 154 may be configured to cause, trigger, instruct and/or control device 140 to operate as, perform a role of, and/or perform one or more operations and/or functionalities of, any other additional or alternative entity and/or STA, e.g., a single STA, multiple STAs, and/or a non-MLD entity.

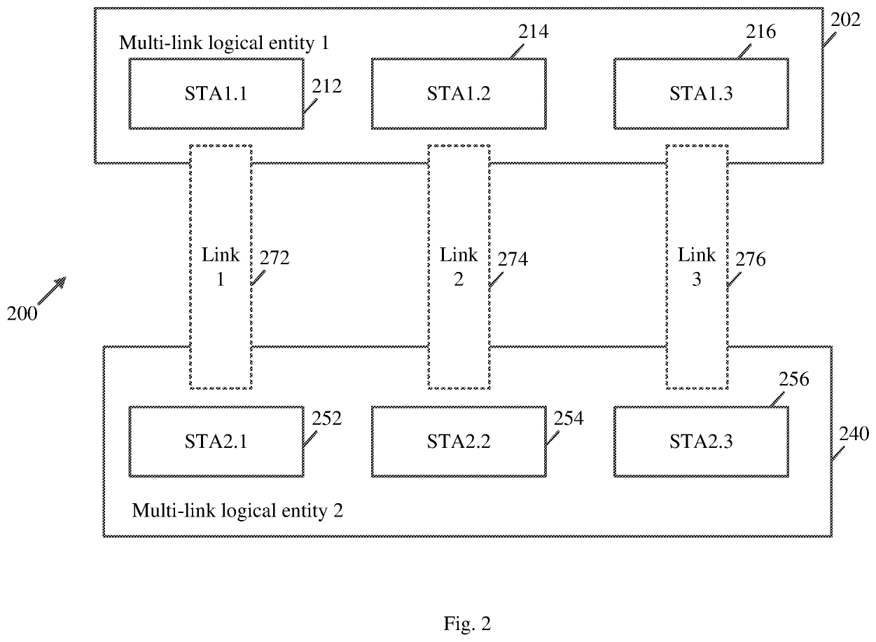

Reference is made to FIG. 2, which schematically illustrates a multi-link communication scheme 200, which may be implemented in accordance with some demonstrative aspects.

As shown in FIG. 2, a first multi-link logical entity 202 (“multi-link logical entity 1”), e.g., a first MLD, may include a plurality of STAs, e.g., including a STA 212, a STA 214, and a STA 216. In one example, AP MLD 131 (FIG. 1) may perform one or more operations, one or more functionalities, the role of, and/or the functionality of, multi-link logical entity 202.

As shown in FIG. 2, a second multi-link logical entity 240 (“multi-link logical entity 2”), e.g., a second MLD, may include a plurality of STAs, e.g., including a STA 252, a STA 254, and a STA 256. In one example, MLD 151 (FIG. 1) may perform one or more operations, one or more functionalities, the role of, and/or the functionality of, multi-link logical entity 240.

As shown in FIG. 2, multi-link logical entity 202 and multi-link logical entity 240 may be configured to form, setup and/or communicate over a plurality of links, for example, including a link 272 between STA 212 and STA 252, a link 274 between STA 214 and STA 254, and/or a link 276 between STA 216 and STA 256.

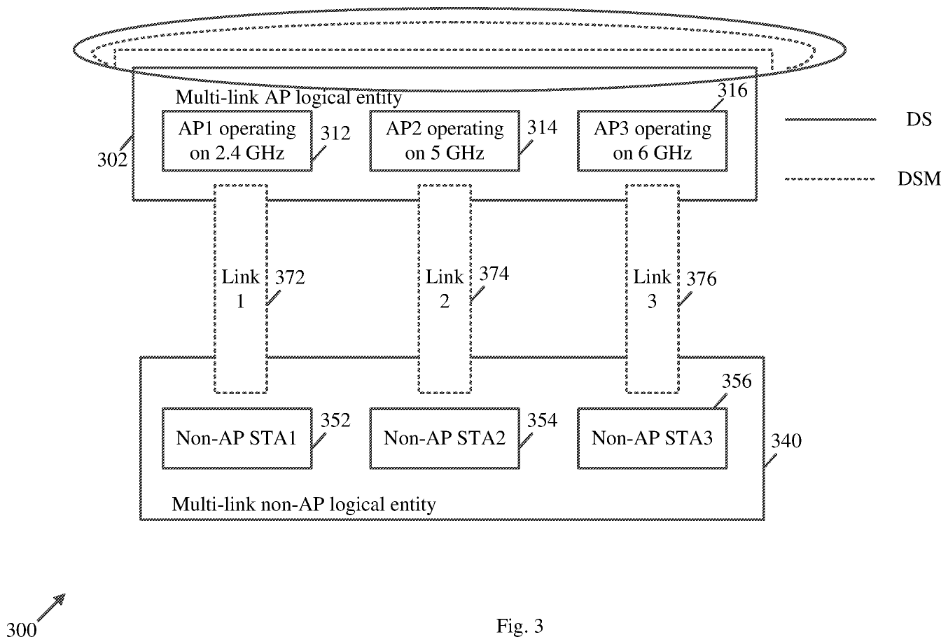

Reference is made to FIG. 3, which schematically illustrates a multi-link communication scheme 300, which may be implemented in accordance with some demonstrative aspects.

As shown in FIG. 3, a multi-link AP logical entity 302, e.g., an AP MLD, may include a plurality of AP STAs, e.g., including an AP STA 312, an AP STA 314, and an AP STA 316. In one example, AP MLD 131 (FIG. 1) may perform one or more operations, one or more functionalities, the role of, and/or the functionality of, multi-link AP logical entity 302.

As shown in FIG. 3, a multi-link non-AP logical entity 340, e.g., a non-AP MLD, may include a plurality of non-AP STAs, e.g., including a non-AP STA 352, a non-AP STA 354, and a non-AP STA 356. In one example, MLD 151 (FIG. 1) may perform one or more operations, one or more functionalities, the role of, and/or the functionality of, multi-link non-AP logical entity 340.

As shown in FIG. 3, multi-link AP logical entity 302 and multi-link non-AP logical entity 340 may be configured to form, setup and/or communicate over a plurality of links, for example, including a link 372 between AP STA 312 and non-AP STA 352, a link 374 between AP STA 314 and non-AP STA 354, and/or a link 376 between AP STA 316 and non-AP STA 356.

For example, as shown in FIG. 3, multi-link AP logical entity 302 may include a multi-band AP MLD, which may be configured to communicate over a plurality of wireless communication frequency bands. For example, as shown in FIG. 3, AP STA 312 may be configured to communicate over a 2.4 GHz frequency band, AP STA 314 may be configured to communicate over a 5 GHz frequency band, and/or AP STA 316 may be configured to communicate over a 6 GHz frequency band. In other aspects, AP STA 312, AP STA 314, and/or AP STA 316, may be configured to communicate over any other additional or alternative wireless communication frequency bands.

Referring back to FIG. 1, in some demonstrative aspects, device 102, device 140 and/or device 150 may be configured to perform one or more operations of a wireless sensing technique, e.g., as describe below.

In some demonstrative aspects, “wireless sensing” (also referred to as “WLAN sensing” or “Wi-Fi sensing”) may refer to a term given to a usage of wireless technology to detect changes in an environment of a device, e.g., an environment of device 102, for example, based on communicated wireless signals, e.g., signals communicated by device 102, for example, with one or more other devices, e.g., including device 140 and/or device 150.

In some demonstrative aspects, the environment of the device may include an area around the device, e.g., within a few centimeters or meters from the device. The area may include a room, a house, an enterprise, and the like.

In some demonstrative aspects, WLAN sensing technology may utilize PHY and/or MAC features of a WLAN STA, e.g., an IEEE 802.11 station and/or any other type of wireless station, to obtain channel measurements that characterize the environment in which the station operates.

In some demonstrative aspects, measurements obtained with WLAN sensing may be used to enable and/or support applications such as, for example, presence detection, proximity detection, device-free positioning, gesture classification, among many others.

In one example, the wireless sensing may include performing radar-like applications. For example, wireless sensing may be used to detect motion in a room, for example, to detect when a person approaches a target device.

In some demonstrative aspects, the wireless sensing may be configured to detect one or more features in the environment, for example, a motion, a presence or proximity, a gesture, a people count, a geometry, a velocity, and/or the like.

In some demonstrative aspects, the wireless sensing may be configured to detect a target in the environment, for example, an object, a human, an animal, and/or the like.

In some demonstrative aspects, device 102, device 140 and/or device 150 may be configured to perform one or more operations of a wireless sensing mechanism, e.g., in accordance with an IEEE 802.11bf Standard and/or any other suitable wireless sensing protocol, standard and/or specification, e.g., as described below.

For example, the wireless sensing mechanism may be configured to use PHY and/or MAC features of one or more STAs, e.g., high-efficiency (HE) STAs and/or EHT STAs, for example, to obtain measurements, which may be useful to estimate one or more features, e.g., range, velocity, and/or motion, of objects in an area of interest.

In some demonstrative aspects, the wireless sensing mechanism may be configured to provide a technical solution to use Wi-Fi technology to perform radar-like applications, such as detecting motion in a room, detecting when a person approaches a target device, and/or performing any other additional or alternative motion detection operations.

In some demonstrative aspects, the wireless sensing mechanism may be configured to provide a technical solution to perform sensing, for example, by tracking channel estimates obtained when decoding multiple Wi-Fi packets over time, and detecting variations that indicate an event of interest.

In some demonstrative aspects, the wireless sensing mechanism may be configured to utilize one or more measurement flows, for example, in accordance with an IEEE 802.11bf Standard, e.g., as described below.

In some demonstrative aspects, the wireless sensing mechanism may be configured according to a Trigger-based (TB) measurement flow, for example, in accordance with an IEEE 802.11bf Standard, e.g., as described below.

In other aspects, the wireless sensing mechanism may be configured according to a Non-Trigger-based (NTB) measurement flow, for example, in accordance with an IEEE 802.11bf Standard, e.g., as described below.

In some demonstrative aspects, TB sensing measurement exchanges may be configured to utilize an AP-centric sensing measurement mechanism, for example, in accordance with an IEEE 802.11bf Standard, e.g., as described below.

For example, the AP may perform one or more operations of, and/or the role of, a sensing initiator, which may be configured to initiate a sensing procedure, e.g., as described below.

In one example, an AP may perform one or more operations of a TB sensing measurement exchange, for example, to manage and/or schedule one or more sensing measurements between the AP and a STA.

In another example, an AP may perform one or more operations of a TB sensing measurement exchange, for example, to manage and/or schedule one or more sensing measurements between two or more STAs.

For example, the AP may initiate a TB sensing measurement exchange in accordance with a STA to STA sensing sounding mechanism, for example, a Sensing Responder to Sensing Responder (SR2SR) sensing sounding, e.g., in accordance with an IEEE 802.11bf Standard.

For example, the AP may schedule a first STA operating as a sensing transmitter to send sensing PPDUs to a second STA operating as a sensing receiver.

For example, a sensing initiator may include a STA, e.g., an HE STA and/or an EHT STA, that initiates a sensing procedure, for example, by transmitting a sensing measurement request frame, or a DMG STA that initiates a DMG sensing procedure by transmitting a DMG Sensing Measurement Request frame. The sensing initiator may perform any other additional or alternative operations, role, and/or functionality.

For example, a sensing responder may include a STA, e.g., an HE STA and/or an EHT STA, that participates in a sensing procedure, for example, by responding to a sensing initiator, or a DMG STA that participates in a DMG sensing procedure, for example, by responding to a sensing initiator. The sensing responder may perform any other additional or alternative operations, role, and/or functionality.

For example, a sensing transmitter may include a STA that transmits PPDUs used for measurements in a sensing procedure and/or in a DMG sensing procedure. The sensing transmitter may perform any other additional or alternative operations, role, and/or functionality.

For example, a sensing receiver may include a STA that is an intended recipient of PPDUs sent by a sensing transmitter to obtain sensing measurements, for example, in either a sensing procedure or a DMG sensing procedure. The sensing receiver may perform any other additional or alternative operations, role, and/or functionality.

In some demonstrative aspects, device 102, device 140 and/or device 150 may be configured to implement one or more operations and/or functionalities of a wireless sensing mechanism, which may be configured to utilize one or more TB sensing measurement exchanges, for example, in accordance with the IEEE 802.11bf Standard, e.g., as described below.

In some demonstrative aspects, a TB sensing measurement exchange may include communication of at least one sounding Null Data PPDU (NDP) between a sensing transmitter and one or more sensing receivers of a TB sensing measurement exchange, e.g., as described below.

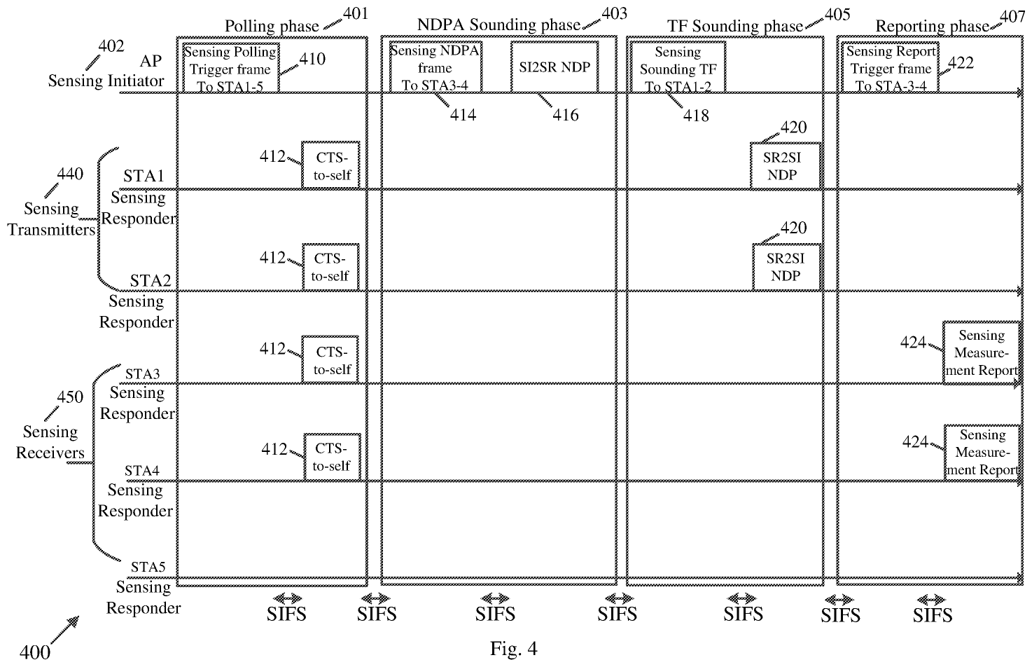

Reference is made to FIG. 4, which schematically illustrates a TB sensing measurement exchange 400, which may be implemented in accordance with some demonstrative aspects.

In some demonstrative aspects, a sensing initiator 402, one or more sensing transmitters 440 and/or one or more sensing receivers 450 may be configured to perform one or more operations of the TB sensing measurement exchange 400, e.g., as described below.

For example, as shown in FIG. 4, an AP may operate as a sensing initiator 402 of the TB sensing measurement exchange 400, e.g., as described below.

For example, as shown in FIG. 4, a first non-AP STA (STA1), a second non-AP STA (STA2), a third non-AP STA (STA3), a fourth non-AP STA (STA4), and a fifth non-AP STA (STAS) may operate as sensing responders of the TB sensing measurement exchange 400, e.g., as described below.

In some demonstrative aspects, as shown in FIG. 4, the TB sensing measurement exchange 400 may include a polling phase 401, an NDP Announcement (NDPA) sounding phase 403, e.g., a Short Interframe Space (SIFS) after the polling phase 401, a Trigger frame (TF) sounding phase 405, e.g., a SIFS after the NDPA sounding phase 403, and/or a reporting phase 407, for example, a SIFS after the TF sounding phase 405, e.g., as described below.

In some demonstrative aspects, the polling 401 phase may be defined as an optional phase in a TB sensing measurement exchange.

In some demonstrative aspects, the polling phase 401 may be defined as a mandatory phase of a TB sensing measurement exchange, for example, in one or more use cases, scenarios and/or implementations, e.g., as described below.

In some demonstrative aspects, as shown in FIG. 4, during the polling phase 401, the AP may send a sensing polling trigger frame 410 to one or more STAs that are assigned to be polled in the TB sensing measurement exchange 400, e.g., as described below.

In some demonstrative aspects, as shown in FIG. 4, during the polling phase 401, a STA addressed by the sensing polling trigger frame 410, that intends to participate in the TB sensing measurement exchange, may respond with a Clear-to-Send-to-self (CTS-to-self) frame 412, for example, a SIFS after receiving the sensing polling trigger frame 410, e.g., as described below.

For example, as shown in FIG. 4, during the polling phase 401, sensing initiator 402 may transmit the sensing polling trigger frame 410 to poll the five sensing responder STAs STA1-STA5 that are assigned to be polled.

For example, as shown in FIG. 4, the STA1 and the STA2 may be assigned to operate as sensing transmitters 440 of the TB sensing measurement exchange 400, e.g., as described below.

For example, the STA3, the STA4, and the STA5 may be assigned to operate as sensing receivers 450 of the TB sensing measurement exchange 400, e.g., as described below.

In some demonstrative aspects, as shown in FIG. 4, four STAs, e.g., STA1, STA2, STA3, and STA4, may respond to the sensing polling trigger frame 410 from sensing initiator 402 with a CTS-to-self frame 412, for example, to confirm that STA1, STA2, STA3, and STA4 can participate in the TB sensing measurement exchange 400.

For example, as shown in FIG. 4, the STA5 may not respond to the sensing polling trigger frame 410 from sensing initiator 402. For example, the STA5 may not participate in the TB sensing measurement exchange 400.

For example, as shown in FIG. 4, STA1, STA2, STA3, and STA4 may transmit the CTS-to-self frame 412 a SIFS after receiving the sensing polling trigger frame 410.

For example, as shown in FIG. 4, both TF sounding phase 405 and the NDPA sounding phase 403 may be present, e.g., since one or more sensing receivers 450 and one or more sensing transmitters 440 have responded to the sensing polling trigger frame 410.

In some demonstrative aspects, as shown in FIG. 4, the NDPA sounding phase 403 may start a SIFS after the polling phase 401.

In some demonstrative aspects, as shown in FIG. 4, during the NDPA sounding phase 403, the AP may transmit a Sensing Initiator to Sensing Responder (SI2SR) NDP frame 414 on which one or more STAs may perform sensing measurements, e.g., as described below.

In some demonstrative aspects, as shown in FIG. 4, sensing initiator 402 may, e.g., shall, transmit the Sensing NDPA frame 414 to one or more STAs operating as the sensing receivers 450 in the NDPA sounding phase 403. For example, the AP may transmit an SI2SR NDP transmission 416 a SIFS after sensing NDPA frame 414.

For example, as shown in FIG. 4, during the NDPA sounding phase 403, sensing initiator 402 may send the sensing NDP Announcement frame 414 to the STA3 and STA4 operating as the sensing receivers 450.

For example, as shown in FIG. 4, sensing initiator 402 may transmit the SI2SR NDP 416 a SIFS after the sensing NDPA frame 414.

In some demonstrative aspects, as shown in FIG. 4, the TF sounding phase 405 may start a SIFS after the NDPA sounding phase 403.

In some demonstrative aspects, the TF sounding phase 405 may include an SR2SI variant, during which sensing initiator 402 may solicit SR2SI NDP transmissions from one or more STAs, on which the AP is to perform sensing measurements, e.g., as described below.

In other aspects, additionally or alternatively, a TF sounding phase may include an SR2SR variant (not shown in FIG. 4). For example, during the SR2SR variant of the TF sounding phase, an AP, e.g., a sensing initiator, may transmit an SR2SR Sounding Trigger frame to solicit NDP transmission from one non-AP STA, on which one or more non-AP STAs may perform sensing measurements.

In some demonstrative aspects, during the TF sounding phase 405, sensing initiator 402 may, e.g., shall, transmit a trigger frame 418 to one or more STAs that operate as sensing transmitters 440 during the TF sounding phase 405, e.g., as described below.

In some demonstrative aspects, sensing initiator 402 may transmit the trigger frame 418 to the one or more STAs that are sensing transmitters 440 in this TF sounding phase 405, for example, to solicit one or more SR2SI NDP transmissions 420.

In some demonstrative aspects, the trigger frame 418 may include an SR2SI sounding trigger frame 418. In other aspects, the trigger frame may include any other additional or alternative type of trigger frame.

In some demonstrative aspects, as shown in FIG. 4, during the TF sounding phase 405, sensing initiator 402 may send the SR2SI sounding trigger frame 418 to sensing transmitters 440, e.g., the STA1 and the STA2, to solicit transmissions of SR2SI NDP frame 420, which may be, for example, multiplexed in a spatial domain.

In some demonstrative aspects, as shown in FIG. 4, a STA addressed by an SR2SI Sounding Trigger frame may, e.g., shall, transmit an SR2SI NDP 420, for example, a SIFS after receiving the SR2SI sounding trigger frame 418.

For example, as shown in FIG. 4, STA1 and/or STA2 may transmit SR2SI NDP frame 420 a SIFS after receiving the SR2SI sounding trigger frame 418.

In some demonstrative aspects, as shown in FIG. 4, the reporting phase 407 may start, for example, a SIFS and/or any other time interval, after the TF sounding phase 405.

In some demonstrative aspects, the reporting phase 407 may include a basic reporting phase, during which sensing initiator 402 may transmit a trigger frame 422, for example, to allocate UL resources to one or more STAs, e.g., as described below.

In some demonstrative aspects, the trigger frame 422 may include a sensing reporting trigger frame 422. In other aspects, the trigger frame 422 may include any other type of frame.

In some demonstrative aspects, as shown in FIG. 4, during the reporting phase 407, sensing initiator 402 may, e.g., shall, send a sensing reporting trigger frame 422 allocating UL resources to one or more sensing receivers 450, for example, in order to obtain one or more sensing measurement report frames 424.

For example, as shown in FIG. 4, the sensing initiator 402 may send sensing reporting trigger frame 422 to STA3 and STA4, for example, in order to obtain sensing measurement report frames 424 from STA3 and STA4.

In some demonstrative aspects, sensing measurement report frame 424 may contain sensing measurement results, for example, based on measurements performed by the sensing receivers 450 on one or more NDP transmissions, e.g., during the NDPA sounding phase 403.

In some demonstrative aspects, as shown in FIG. 4, during the reporting phase 407, STA3 and/or STA4 may send sensing measurement results to the sensing initiator 402, for example, a SIFS and/or any other time interval, after receiving sensing reporting trigger frame 422.

In some demonstrative aspects, as shown in FIG. 4, STA5 may refrain from sending sensing measurement results, for example, since STA5 is not assigned to transmit a sensing measurement report frame.

Referring back to FIG. 1, in some demonstrative aspects, device 102, device 140 and/or device 150 may be configured to communicate according to a multi-link communication mechanism, e.g., as described below.

In some demonstrative aspects, device 102, device 140 and/or device 150 may be configured to communicate according to a multi-link communication mechanism, which may implement one or more operations and/or functionalities for communication at an Enhanced Multilink Single-Radio (EMLSR) operation mode, e.g., in accordance with an IEEE 802.11 Specification and/or a Wi-Fi7 Specification, e.g., as described below.

In some demonstrative aspects, the EMLSR operation mode may be defined, e.g., in compliance with an IEEE 802.11be Specification, to include a mode of operation that allows a non-AP MLD with multiple receive chains to listen on a set of enabled links, for example, when the corresponding STAs affiliated with the non-AP MLD are in the awake state, for an initial control frame sent by an AP affiliated with an AP MLD.

For example, the initial control frame may be sent by the AP in a non-high-throughput (non-HT) (duplicate) PPDU, for example, with one spatial stream.

For example, the initial control frame may be followed by one or more frame exchanges on the link on which the initial Control frame was received.

In other aspects, the EMLSR operation mode may be defined to include any other additional or alternative suitable functionality.

Some demonstrative aspects are described herein with respect to a wireless communication device, e.g., wireless communication device 102, operating according to an EMLSR operation mode. Other aspects may be implemented with respect to a wireless communication device, e.g., wireless communication device 102, operating according to any other additional or alternative multi-link operation mode.

For example, an EMLSR STA may include a STA that may listen to multiple links at the same time, and then switch to one link for frame exchanges, e.g., as described below.

For example, it may be defined, e.g., in accordance with an IEEE 802.11be Specification, that for DL traffic on a particular link, an AP may be required to send to the EMLSR STA a Multi-User Request to Send (MU-RTS) trigger frame, or a Buffer Status Report Poll (BSRP) trigger frame, as an Initial Control Frame (ICF), for example, prior to the DL traffic, for example, such that the EMLSR STA may be triggered to switch to the link and receive the DL traffic from the AP.

For example, according to this definition, the EMLSR STA may not be able to receive any DL traffic from the AP, e.g., in case the AP does not transmit the ICF to the EMLSR STA.

In some demonstrative aspects, device 102, device 140 and/or device 150 may be configured to implement one or more operations and/or functionalities of a wireless sensing mechanism, which may be configured to provide a technical solution to implement wireless sensing, for example, in accordance with an IEEE 802.11bf Specification, for example, while supporting the EMLSR operation mode, for example, in accordance with an IEEE 802.11be Specification, e.g., as described below.

In some demonstrative aspects, device 102, device 140 and/or device 150 may be configured to implement one or more operations and/or functionalities of a wireless sensing mechanism, which may be configured to provide a technical solution to accommodate EMLSR STAs, e.g., STAs operating in an EMLSR operation mode and/or any other multi-link operation mode, to participate in a TB sensing measurement exchange, e.g., as described below.

In some demonstrative aspects, device 102, device 140 and/or device 150 may be configured to implement one or more operations and/or functionalities of a wireless sensing mechanism, which may be configured to provide a technical solution to enhance SR2SR sensing sounding, for example, in accordance with an IEEE 802.11bf Specification, e.g., as described below.

In some demonstrative aspects, the wireless sensing mechanism may be configured to provide a technical solution to guarantee that one or more Multi-Link Operation (MLO) STAs, e.g., EMLSR STAs in accordance with an IEEE 802.11be Specification, may be able to participate in a TB sensing measurement exchange, e.g., in accordance with an IEEE 802.11bf Specification, for example, without any substantial issues.

In some demonstrative aspects, the wireless sensing mechanism may be configured to provide a technical solution to reuse an existing protocol, e.g., in accordance with an IEEE 802.11be Specification, for example, to enhance the SR2SR sensing sounding, e.g., with minimal changes.

In some demonstrative aspects, the wireless sensing mechanism may be configured to define that an AP is to be required to send, e.g., to always send, an ICF, for example, before initiating the TB sensing measurement exchange, e.g., as described below.

In some demonstrative aspects, it may be defined, for example, that if a TB sensing measurement exchange includes at least one non-AP STA operating in an EMLSR mode, then the AP shall transmit an ICF to the non-AP STA, for example, before initiating the TB sensing measurement exchange, e.g., as described below.

In some demonstrative aspects, the AP may transmit an MU-RTS trigger frame to a non-AP STA operating in an EMLSR operation mode and/or any other multi-link operation mode, for example, before initiating the TB sensing measurement exchange, e.g., as described below.

In some demonstrative aspects, the AP may transmit a BSRP trigger frame to a non-AP STA operating in an EMLSR operation mode and/or any other multi-link operation mode, for example, before initiating the TB sensing measurement exchange, e.g., as described below.

In other aspects, the AP may transmit to a non-AP STA operating in an EMLSR operation mode and/or any other multi-link operation mode any other additional or alternative type of trigger frame before initiating the TB sensing measurement exchange.

In some demonstrative aspects, it may be defined, for example, that if a TB sensing measurement exchange includes at least one EMLSR capable STA and the EMLSR capable STA is operating in an EMLSR mode, then the AP shall transmit an ICF, e.g., either an MU-RTS Trigger frame or a BSRP Trigger, to the EMLSR STA, for example, before initiating a TB sensing measurement exchange, e.g., as described below.

In some demonstrative aspects, controller 124 may be configured to control, trigger, cause, and/or instruct an AP implemented by device 102 to identify a TB sensing measurement exchange of a WLAN sensing procedure to be initiated by the AP, e.g., as described below.

In some demonstrative aspects, controller 124 may be configured to control, trigger, cause, and/or instruct the AP implemented by device 102 to transmit an ICF addressed to a non-AP MLD, e.g., a non-AP MLD implemented by device 140, for example, prior to initiating the TB sensing measurement exchange, e.g., as described below.

In some demonstrative aspects, controller 124 may be configured to control, trigger, cause, and/or instruct the AP implemented by device 102 to transmit the ICF addressed to the non-AP MLD prior to initiating the TB sensing measurement exchange, for example, based on a determination that the non-AP MLD is at an EMLSR operation mode and is to participate as a sensing responder of the TB sensing measurement exchange, e.g., as described below.

In some demonstrative aspects, the TB sensing measurement exchange may include communication of at least one sounding NDP between the AP and one or more sensing responders of the TB sensing measurement exchange, e.g., as described above.

In some demonstrative aspects, controller 124 may be configured to control, trigger, cause, and/or instruct the AP implemented by device 102 to transmit the ICF addressed to the non-AP MLD, for example, over a link between the AP and the non-AP MLD, which is to be used for the TB sensing measurement exchange.

In some demonstrative aspects, the ICF may include a trigger frame, e.g., as described above.

In some demonstrative aspects, the ICF may include an MU-RTS trigger frame, e.g., as described above.

In some demonstrative aspects, the ICF may include a BSRP trigger frame, e.g., as described above.

In other aspects, the ICF may include any other additional or alternative type of frame.

In some demonstrative aspects, device 102, device 140 and/or device 150 may be configured to perform one or more operations of a wireless sensing mechanism, which may be configured to utilize a sensing polling trigger frame as an ICF for a non-AP MLD operating in an EMLSR operation mode and/or any other multi-link operation mode, e.g., as described below.

In some demonstrative aspects, a sensing polling trigger frame, e.g., sensing polling trigger frame 410 (FIG. 4), may be defined as a valid ICF, e.g., in addition to the MU-RTS trigger frame and the BSRP trigger frame, e.g., as described below.

In some demonstrative aspects, a sensing polling trigger frame, e.g., sensing polling trigger frame 410 (FIG. 4), may be defined as a valid ICF, which may be used by an AP to trigger a non-AP STA at the EMLSR operation mode to transition to exchange communications with the AP on the link where the sensing polling trigger frame is transmitted from the AP to the non-AP STA, e.g., as described below.

In some demonstrative aspects, controller 124 may be configured to control, trigger, cause, and/or instruct an AP implemented by device 102 to mandate the AP to perform a polling phase at a beginning of a TB sensing measurement exchange of a WLAN sensing procedure, for example, based on a determination that a non-AP MLD at an EMLSR operation mode, e.g., a non-AP MLD implemented by device 140, is to participate as a sensing responder of the TB sensing measurement exchange, e.g., as described below.

In some demonstrative aspects, controller 124 may be configured to control, trigger, cause, and/or instruct the AP implemented by device 102 to transmit a sensing polling trigger frame, e.g., sensing polling trigger frame 410 (FIG. 4), to initiate the polling phase of the TB sensing measurement exchange, e.g., as described below.

In some demonstrative aspects, the TB sensing measurement exchange may include communication of at least one sounding NDP between the AP and one or more sensing responders of the TB sensing measurement exchange, e.g., as described below.

In some demonstrative aspects, controller 124 may be configured to control, trigger, cause, and/or instruct the AP implemented by device 102 to start with a polling phase any TB sensing measurement exchange involving at least one non-AP MLD at the EMLSR operation mode, e.g., as described below.

For example, it may be mandated that an AP is to include a poling phase in any TB sensing measurement exchange involving at least one non-AP MLD at the EMLSR operation mode, e.g., as described below.

In some demonstrative aspects, controller 124 may be configured to control, trigger, cause, and/or instruct the AP implemented by device 102 to assign a non-AP STA of the non-AP MLD to be polled in the TB sensing measurement exchange, for example, based on a determination that the non-AP MLD is capable of operating at the EMLSR operation mode, e.g., as described below.

For example, the AP implemented by device 102 may assign a non-AP STA 155 of non-AP MLD 151 to be polled in the TB sensing measurement exchange, for example, based on a determination that the non-AP MLD 151 is capable of operating at the EMLSR operation mode.

In some demonstrative aspects, controller 124 may be configured to control, trigger, cause, and/or instruct the AP implemented by device 102 to transmit to a non-AP STA of the non-AP MLD an indication that the non-AP STA of the non-AP MLD is assigned to be polled in the TB sensing measurement exchange, for example, based on a determination that the non-AP MLD is capable of operating at the EMLSR operation mode, e.g., as described below.

For example, the AP implemented by device 102 may transmit to the non-AP STA 155 of the non-AP MLD 151 an indication that STA 155 is assigned to be polled in the TB sensing measurement exchange, for example, based on a determination that the non-AP MLD 151 is capable of operating at the EMLSR operation mode.

In some demonstrative aspects, controller 124 may be configured to control, trigger, cause, and/or instruct the AP implemented by device 102 to set a poll-assigned field to “1” in a TB specific element in a sensing measurement request frame addressed to a non-AP STA of the non-AP MLD, for example, based on a determination that the non-AP MLD is capable of operating at the EMLSR operation mode, e.g., as described below.

For example, the AP implemented by device 102 may set a poll-assigned field to “1” in a TB specific element in a sensing measurement request frame addressed to the non-AP STA 155 of the non-AP MLD 151, for example, based on a determination that the non-AP MLD 151 is capable of operating at the EMLSR operation mode.

In some demonstrative aspects, controller 124 may be configured to control, trigger, cause, and/or instruct the AP implemented by device 102 to transmit the sensing polling trigger frame, e.g., sensing polling trigger frame 410 (FIG. 4), for example, according to a transmit configuration of an ICF defined for the EMLSR operation mode, e.g., as described below.

In some demonstrative aspects, controller 124 may be configured to control, trigger, cause, and/or instruct the AP implemented by device 102 to transmit the sensing polling trigger frame in a non-HT PPDU format, e.g., as described below.

In some demonstrative aspects, controller 124 may be configured to control, trigger, cause, and/or instruct the AP implemented by device 102 to transmit the sensing polling trigger frame in a non-HT duplicate PPDU format, e.g., as described below.

In other aspects, controller 124 may be configured to control, trigger, cause, and/or instruct the AP implemented by device 102 to transmit the sensing polling trigger frame in any other additional or alternative suitable format of an ICF.

In some demonstrative aspects, controller 124 may be configured to control, trigger, cause, and/or instruct the AP implemented by device 102 to transmit the sensing polling trigger frame at a data rate of 6 Megabits per second (Mb/s), 12 Mb/s, 24 Mb/s, or at any other additional or alternative suitable rate.

In some demonstrative aspects, controller 154 may be configured to control, trigger, cause, and/or instruct a non-AP MLD implemented by device 140 to operate one or more non-AP STAs of the non-AP MLD to listen over one or more links of the non-AP MLD for an ICF from an AP, for example, when the non-AP MLD is at an EMLSR operation mode, e.g., as described below.

In some demonstrative aspects, controller 154 may be configured to control, trigger, cause, and/or instruct the non-AP MLD implemented by device 140 to determine receipt of the ICF from the AP, for example, based on receipt of a sensing polling trigger frame from the AP at a non-AP STA of the one or more non-AP STAs of the non-AP MLD, e.g., as described below.

For example, controller 154 may be configured to control, trigger, cause, and/or instruct non-AP MLD 151 to determine receipt of the ICF from the AP, for example, based on receipt of sensing polling trigger frame 410 (FIG. 4) from the AP at non-AP STA 155.

In some demonstrative aspects, controller 154 may be configured to control, trigger, cause, and/or instruct the non-AP MLD implemented by device 140 to operate the non-AP STA, e.g., non-AP STA 155, to participate as a sensing responder of a TB sensing measurement exchange with the AP, for example, based on the sensing polling trigger frame from the AP, e.g., as described below.

In some demonstrative aspects, the sensing polling trigger frame received by the non-AP STA 155 may include the sensing polling trigger frame, e.g., the sensing polling trigger frame 410 (FIG. 4), transmitted by the AP implemented by device 102.

In some demonstrative aspects, the sensing polling trigger frame from the AP may be addressed to the non-AP STA, e.g., non-AP STA 155, of the non-AP MLD implemented by device 140, e.g., as described below.

In some demonstrative aspects, the TB sensing measurement exchange may include communication of at least one sounding NDP between the non-AP STA and the AP, e.g., as described above.

In other aspects, the TB sensing measurement exchange may include communication of any other additional or alternative type of frame between the non-AP STA and the AP.

In some demonstrative aspects, controller 154 may be configured to control, trigger, cause, and/or instruct the non-AP MLD implemented by device 140 to operate the non-AP STA to receive the sensing polling trigger frame, which may be configured, for example, according to a transmit configuration of an ICF defined for the EMLSR operation mode, e.g., as described below.

In some demonstrative aspects, controller 154 may be configured to control, trigger, cause, and/or instruct the non-AP MLD implemented by device 140 to operate the non-AP STA to receive the sensing polling trigger frame at a data rate of 6 Mb/s, 12 Mb/s, or 24 Mb/s.

In other aspects, controller 154 may be configured to control, trigger, cause, and/or instruct the non-AP MLD implemented by device 140 to operate the non-AP STA to receive the sensing polling trigger frame at any other suitable rate.

In some demonstrative aspects, controller 154 may be configured to control, trigger, cause, and/or instruct the non-AP MLD implemented by device 140 to operate the non-AP STA to receive the sensing polling trigger frame in a non-HT PPDU format, e.g., as described below.

In some demonstrative aspects, controller 154 may be configured to control, trigger, cause, and/or instruct the non-AP MLD implemented by device 140 to operate the non-AP STA to receive the sensing polling trigger frame in a non-HT duplicate PPDU format, e.g., as described below.

In other aspects, controller 154 may be configured to control, trigger, cause, and/or instruct the non-AP MLD implemented by device 140 to operate the non-AP STA to receive the sensing polling trigger frame in any other additional or alternative suitable format.

In some demonstrative aspects, controller 154 may be configured to control, trigger, cause, and/or instruct the non-AP STA of the non-AP MLD implemented by device 140 to operate the non-AP STA to participate as the sensing responder of the TB sensing measurement exchange with the AP, for example, over a link on which the sensing polling trigger frame from the AP is received by the non-AP STA, e.g., as described below.

In some demonstrative aspects, controller 154 may be configured to control, trigger, cause, and/or instruct the non-AP STA of the non-AP MLD implemented by device 140 to transmit an immediate response to the AP, for example, over a link on which the sensing polling trigger frame from the AP is received by the non-AP STA, e.g., as described below.

In some demonstrative aspects, the immediate response to the AP may include a CTS-to-self frame.

For example, controller 154 may be configured to control, trigger, cause, and/or instruct the non-AP STA 155 to transmit a CTS-to-self frame 412 (FIG. 4) as an immediate response to the AP, for example, over a link on which the sensing polling trigger frame 410 (FIG. 4) is received from the AP.

In other aspects, the immediate response to the AP may include any other type of frame.

In some demonstrative aspects, controller 154 may be configured to control, trigger, cause, and/or instruct the non-AP MLD implemented by device 140 to, based on receipt of the sensing polling trigger frame from the AP, allow the non-AP STA at which the sensing polling trigger frame is received to transmit and/or receive frames over a link on which the sensing polling trigger frame from the AP is received, e.g., as described below.

In some demonstrative aspects, device 102, device 140 and/or device 150 may be configured to perform one or more operations and/or functionalities of a wireless sensing mechanism, which may be configured to define that the sensing polling trigger frame is to be considered as another valid option for an initial control frame, e.g., as described below.

In some demonstrative aspects, the wireless sensing mechanism may define the sensing polling trigger frame as another valid option for the initial control frame, for example, in addition to an existing MU-RTS trigger frame and/or an existing BSRP trigger frame, e.g., as described below.

In some demonstrative aspects, the wireless sensing mechanism may define the sensing polling trigger frame as another valid option for the initial control frame for non-AP STAs, for example, EMLSR STAs operating at an EMLSR operation mode and/or any other predefined multi-link operation mode, e.g., as described below.

In some demonstrative aspects, the wireless sensing mechanism may define the sensing polling trigger frame as another valid option for the initial control frame to trigger a transition process of a STA operating in the EMLSR operation mode and/or any other predefined multi-link operation mode, for example, to be able to transmit and/or receive one or more frames on a link where the sensing polling trigger frame is transmitted, e.g., as described below.

In some demonstrative aspects, the wireless sensing mechanism may define that, for example, if a STA is an EMLSR capable STA, e.g., is capable of operating in an EMLSR operation mode, and/or any other predefined type of STA capable of operating in other predefined multi-link operation mode, then an AP may assign, e.g., shall always assign, the STA to be polled in a TB sensing measurement exchange.

For example, the AP may set, e.g., shall always set, a “Poll Assigned” field to 1 in the TB Sensing Specific sub-element within the sensing measurement request frame addressed to the EMLSR capable STA, and/or any other predefined type of STA capable of operating in any other predefined multi-link operation mode.

In some demonstrative aspects, it may be defined that, for example, if a TB sensing measurement exchange includes at least one EMLSR capable STA and the EMLSR capable STA is operating in the EMLSR mode, then the TB sensing measurement exchange may start, e.g., shall always start, with a polling phase, e.g., as described above.

In other aspects, it may be defined that, for example, if a TB sensing measurement exchange includes at least one predefined type of STA operating in any other predefined multi-link operation mode, then the TB sensing measurement exchange may start, e.g., shall always start, with a polling phase, e.g., as described above.

In some demonstrative aspects, it may be defined that the AP may, e.g., shall, send the sensing polling trigger frame configured according to a transmit configuration of an ICF, e.g., as described above.

In some demonstrative aspects, it may be defined that the AP may, e.g., shall, send the sensing polling trigger frame in a non-HT PPDU format and/or non-HT duplicate PPDU format, e.g., as described above.

In some demonstrative aspects, it may be defined that the AP may, e.g., shall, send the sensing polling trigger frame, for example, using a rate of 6 Mb/s, 12 Mb/s, 24 Mb/s, or any other additional or alternative rate.

In some demonstrative aspects, it may be defined that the wireless sensing mechanism may utilize one or more rules for an MU-RTS trigger frame and/or a BSRP trigger frame, e.g., in accordance with an IEEE 802.11be Specification.

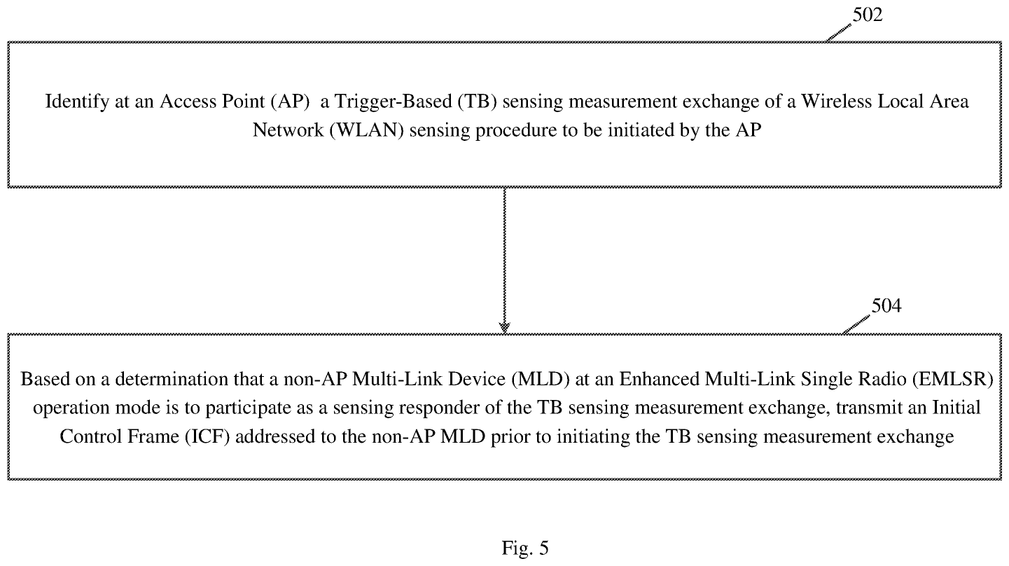

Reference is made to FIG. 5, which schematically illustrates a method of a sensing measurement exchange, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1), device 140 (FIG. 1) and/or device 150 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include identifying, at an AP, a TB sensing measurement exchange of a WLAN sensing procedure to be initiated by the AP. For example, controller 124 (FIG. 1) may be configured to cause, trigger, and/or control an AP implemented by device 102 (FIG. 1) to identify a TB sensing measurement exchange of a WLAN sensing procedure to be initiated by the AP implemented by device 102 (FIG. 1), e.g., as described above.

As indicated at block 504, the method may include transmitting an ICF addressed to a non-AP MLD prior to initiating the TB sensing measurement exchange, for example, based on a determination that the non-AP MLD is at an EMLSR operation mode and is to participate as a sensing responder of the TB sensing measurement exchange. For example, controller 124 (FIG. 1) may be configured to cause, trigger, and/or control the AP implemented by device 102 (FIG. 1) to transmit an ICF addressed to a non-AP MLD implemented by device 140 (FIG. 1) prior to initiating the TB sensing measurement exchange, for example, based on a determination that device 140 (FIG. 1) is at an EMLSR operation mode and is to participate as a sensing responder of the TB sensing measurement exchange, e.g., as described above.

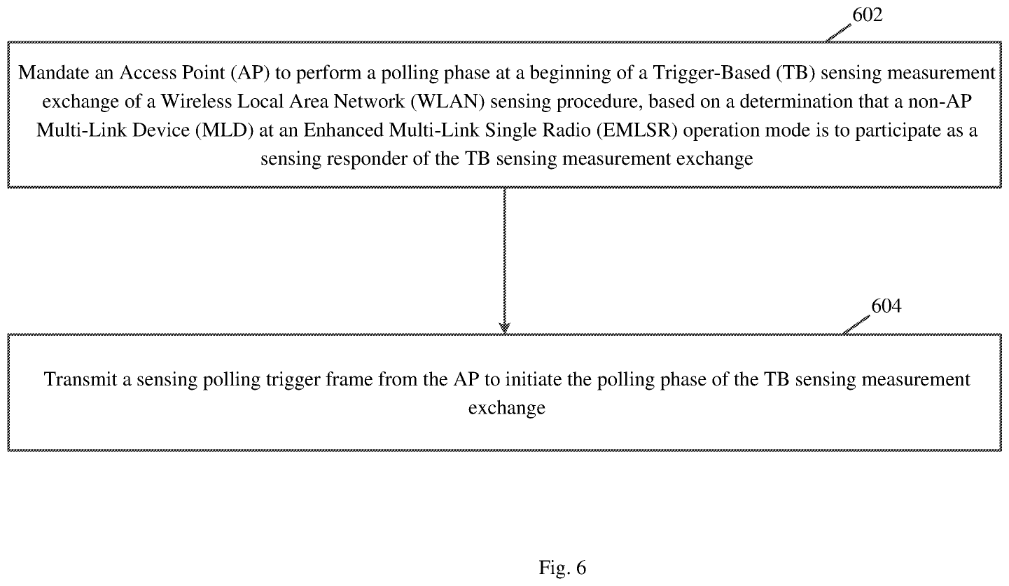

Reference is made to FIG. 6, which schematically illustrates a method of a sensing measurement exchange, in accordance with some demonstrative aspects. For example, one or more of the operations of the method of FIG. 6 may be performed by one or more elements of a system, e.g., system 100 (FIG. 1), for example, one or more wireless devices, e.g., device 102 (FIG. 1), device 140 (FIG. 1) and/or device 150 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 602, the method may include mandating an AP to perform a polling phase at a beginning of a TB sensing measurement exchange of a WLAN sensing procedure, for example, based on a determination that a non-AP MLD at an EMLSR operation mode is to participate as a sensing responder of the TB sensing measurement exchange. For example, controller 124 (FIG. 1) may be configured to cause, trigger, and/or control an AP implemented by device 102 (FIG. 1) to mandate the AP implemented by device 102 (FIG. 1) to perform a polling phase at a beginning of a TB sensing measurement exchange of a WLAN sensing procedure, for example, based on a determination that a non-AP MLD implemented by device 140 (FIG. 1) is at an EMLSR operation mode and is to participate as a sensing responder of the TB sensing measurement exchange, e.g., as described above.

As indicated at block 604, the method may include transmitting a sensing polling trigger frame to initiate the polling phase of the TB sensing measurement exchange. For example, controller 124 (FIG. 1) may be configured to cause, trigger, and/or control the AP implemented by device 102 (FIG. 1) to transmit a sensing polling trigger frame to initiate the polling phase of the TB sensing measurement exchange, e.g., as described above.

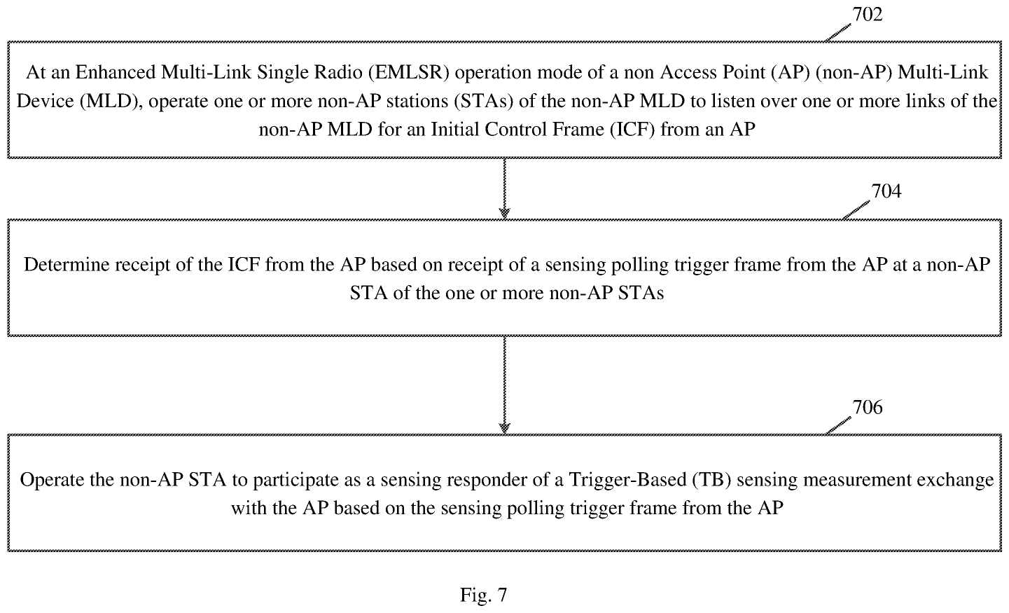

Reference is made to FIG. 7, which schematically illustrates a method of a sensing measurement exchange, in accordance with some demonstrative aspects. For example, one or more of the operations of the method of FIG. 7 may be performed by one or more elements of a system, e.g., system 100 (FIG. 1), for example, one or more wireless devices, e.g., device 102 (FIG. 1), device 140 (FIG. 1) and/or device 150 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 702, the method may include operating, at a non-AP MLD at an EMLSR operation mode, one or more non-AP STAs of the non-AP MLD to listen over one or more links of the non-AP MLD for an ICF from an AP. For example, controller 154 (FIG. 1) may be configured to cause, trigger, and/or control a non-AP MLD implemented by device 140 (FIG. 1), when at an EMLSR operation mode, to operate one or more non-AP STAs of the non-AP MLD to listen over one or more links of the AP-MLD for an ICF from the AP implemented by device 102 (FIG. 1), e.g., as described above.

As indicated at block 704, the method may include determining receipt of the ICF from the AP, for example, based on receipt of a sensing polling trigger frame from the AP at a non-AP STA of the one or more non-AP STAs. For example, controller 154 (FIG. 1) may be configured to cause, trigger, and/or control the non-AP MLD implemented by device 140 (FIG. 1) to determine receipt of the ICF from the AP implemented by device 102 (FIG. 1), for example, based on receipt of a sensing polling trigger frame 410 (FIG. 4) from the AP implemented by device 102 (FIG. 1), for example, at STA 155 (FIG. 1), e.g., as described above.

As indicated at block 706, the method may include operating the non-AP STA to participate as a sensing responder of a TB sensing measurement exchange with the AP, for example, based on the sensing polling trigger frame from the AP. For example, controller 154 (FIG. 1) may be configured to cause, trigger, and/or control the non-AP MLD implemented by device 140 (FIG. 1) to operate STA 155 (FIG. 1) to participate as a sensing responder of a TB sensing measurement exchange with device 102 (FIG. 1), for example, based on the sensing polling trigger frame received at the STA 155 (FIG. 1) from the AP implemented by device 102 (FIG. 1), e.g., as described above.

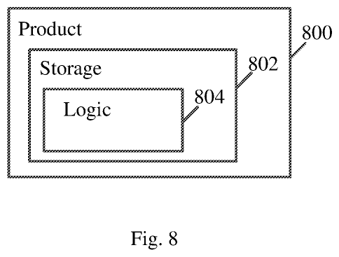

Reference is made to FIG. 8, which schematically illustrates a product of manufacture 800, in accordance with some demonstrative aspects. Product 800 may include one or more tangible computer-readable (“machine-readable”) non-transitory storage media 802, which may include computer-executable instructions, e.g., implemented by logic 804, operable to, when executed by at least one computer processor, enable the at least one computer processor to implement one or more operations at device 102 (FIG. 1), device 140 (FIG. 1), device 150 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 150 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1, 2, 3, 4, 5, 6, and/or 7, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 800 and/or machine readable storage media 802 may include one or more types of computer-readable storage media capable of storing data, including volatile memory, non-volatile memory, removable or non-removable memory, erasable or non-erasable memory, writeable or re-writeable memory, and the like. For example, machine readable storage media 802 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 804 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 804 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### Examples

The following examples pertain to further aspects.

Example 1 includes an apparatus comprising logic and circuitry configured to cause an Access Point (AP) to identify a Trigger-Based (TB) sensing measurement exchange of a Wireless Local Area Network (WLAN) sensing procedure to be initiated by the AP; and, based on a determination that a non-AP Multi-Link Device (MLD) at an Enhanced Multi-Link Single Radio (EMLSR) operation mode is to participate as a sensing responder of the TB sensing measurement exchange, transmit an Initial Control Frame (ICF) addressed to the non-AP MLD prior to initiating the TB sensing measurement exchange.

Example 2 includes the subject matter of Example 1, and optionally, wherein the apparatus is configured to cause the AP to transmit the ICF addressed to the non-AP MLD over a link between the AP and the non-AP MLD, which is to be used for the TB sensing measurement exchange.

Example 3 includes the subject matter of Example 1 or 2, and optionally, wherein the ICF comprises a trigger frame.

Example 4 includes the subject matter of any one of Examples 1-3, and optionally, wherein the ICF comprises a Multi-User Request to Send (MU-RTS) trigger frame or a Buffer Status Report Poll (BSRP) trigger frame.

Example 5 includes the subject matter of any one of Examples 1-4, and optionally, wherein the TB sensing measurement exchange comprises communication of at least one sounding Null Data Physical layer protocol data unit (NDP) between the AP and one or more sensing responders of the TB sensing measurement exchange.

Example 6 includes the subject matter of any one of Examples 1-5, and optionally, comprising at least one radio to transmit the ICF from the AP.

Example 7 includes the subject matter of Example 6, and optionally, comprising one or more antennas connected to the radio, and a processor to execute instructions of an operating system.

Example 8 includes an apparatus comprising logic and circuitry configured to cause an Access Point (AP) to mandate the AP to perform a polling phase at a beginning of a Trigger-Based (TB) sensing measurement exchange of a Wireless Local Area Network (WLAN) sensing procedure, based on a determination that a non-AP Multi-Link Device (MLD) at an Enhanced Multi-Link Single Radio (EMLSR) operation mode is to participate as a sensing responder of the TB sensing measurement exchange; and transmit a sensing polling trigger frame to initiate the polling phase of the TB sensing measurement exchange.

Example 9 includes the subject matter of Example 8, and optionally, wherein the apparatus is configured to cause the AP to, based on a determination that the non-AP MLD is capable of operating at the EMLSR operation mode, assign a non-AP station (STA) of the non-AP MLD to be polled in the TB sensing measurement exchange.

Example 10 includes the subject matter of Example 8 or 9, and optionally, wherein the apparatus is configured to cause the AP to, based on a determination that the non-AP MLD is capable of operating at the EMLSR operation mode, transmit to a non-AP station (STA) of the non-AP MLD an indication that the non-AP STA of the non-AP MLD is assigned to be polled in the TB sensing measurement exchange.

Example 11 includes the subject matter of any one of Examples 8-10, and optionally, wherein the apparatus is configured to cause the AP to set a poll-assigned field to “1” in a TB specific element in a sensing measurement request frame addressed to a non-AP station (STA) of the non-AP MLD, based on a determination that the non-AP MLD is capable of operating at the EMLSR operation mode.

Example 12 includes the subject matter of any one of Examples 8-11, and optionally, wherein the apparatus is configured to cause the AP to transmit the sensing polling trigger frame according to a transmit configuration of an Initial Control Frame (ICF) defined for the EMLSR operation mode.

Example 13 includes the subject matter of any one of Examples 8-12, and optionally, wherein the apparatus is configured to cause the AP to transmit the sensing polling trigger frame in a non-High-Throughput (non-HT) Physical Layer Protocol Data Unit (PPDU) or a non-HT duplicate PPDU format.

Example 14 includes the subject matter of any one of Examples 8-13, and optionally, wherein the apparatus is configured to cause the AP to transmit the sensing polling trigger frame at a data rate of 6 Megabits per second (Mb/s), 12 Mb/s, or 24 Mb/s.

Example 15 includes the subject matter of any one of Examples 8-14, and optionally, wherein the apparatus is configured to cause the AP to start with a polling phase any TB sensing measurement exchange involving at least one non-AP MLD at the EMLSR operation mode.

Example 16 includes the subject matter of any one of Examples 8-15, and optionally, wherein the TB sensing measurement exchange comprises communication of at least one sounding Null Data Physical layer protocol data unit (NDP) between the AP and one or more sensing responders of the TB sensing measurement exchange.

Example 17 includes the subject matter of any one of Examples 8-16, and optionally, comprising at least one radio to transmit the sensing polling trigger frame from the AP.

Example 18 includes the subject matter of Example 17, and optionally, comprising one or more antennas connected to the radio, and a processor to execute instructions of an operating system.

Example 19 includes an apparatus comprising logic and circuitry configured to cause a non Access Point (AP) (non-AP) Multi-Link Device (MLD) to, at an Enhanced Multi-Link Single Radio (EMLSR) operation mode of the non-AP MLD, operate one or more non-AP stations (STAs) of the non-AP MLD to listen over one or more links of the non-AP MLD for an Initial Control Frame (ICF) from an AP; determine receipt of the ICF from the AP based on receipt of a sensing polling trigger frame from the AP at a non-AP STA of the one or more non-AP STAs; and operate the non-AP STA to participate as a sensing responder of a Trigger-Based (TB) sensing measurement exchange with the AP based on the sensing polling trigger frame from the AP.

Example 20 includes the subject matter of Example 19, and optionally, wherein the apparatus is configured to cause the non-AP STA to operate the non-AP STA to participate as the sensing responder of the TB sensing measurement exchange with the AP over a link on which the sensing polling trigger frame from the AP is received.

Example 21 includes the subject matter of Example 19 or 20, and optionally, wherein the apparatus is configured to cause the non-AP STA to transmit an immediate response to the AP over a link on which the sensing polling trigger frame from the AP is received.

Example 22 includes the subject matter of Example 21, and optionally, wherein the immediate response to the AP comprises a Clear to Send to self (CTS-to-self) frame.

Example 23 includes the subject matter of any one of Examples 19-22, and optionally, wherein the apparatus is configured to cause the non-AP MLD to, based on receipt of the sensing polling trigger frame from the AP, allow the non-AP STA to transmit and receive frames over a link on which the sensing polling trigger frame from the AP is received.

Example 24 includes the subject matter of any one of Examples 19-23, and optionally, wherein the apparatus is configured to cause the non-AP MLD to operate the non-AP STA to receive the sensing polling trigger frame configured according to a transmit configuration of an Initial Control Frame (ICF) defined for the EMLSR operation mode.

Example 25 includes the subject matter of any one of Examples 19-24, and optionally, wherein the apparatus is configured to cause the non-AP MLD to operate the non-AP STA to receive the sensing polling trigger frame in a non-High-Throughput (non-HT) Physical Layer Protocol Data Unit (PPDU) or a non-HT duplicate PPDU format.

Example 26 includes the subject matter of any one of Examples 19-25, and optionally, wherein the apparatus is configured to cause the non-AP MLD to operate the non-AP STA to receive the sensing polling trigger frame at a data rate of 6 Megabits per second (Mb/s), 12 Mb/s, or 24 Mb/s.

Example 27 includes the subject matter of any one of Examples 19-26, and optionally, wherein the TB sensing measurement exchange comprises communication of at least one sounding Null Data Physical layer protocol data unit (NDP) between the non-AP STA and the AP.

Example 28 includes the subject matter of any one of Examples 19-27, and optionally, wherein the sensing polling trigger frame from the AP is addressed to the non-AP STA.

Example 29 includes the subject matter of any one of Examples 19-28, and optionally, comprising a radio to receive the sensing polling trigger frame from the AP.

Example 30 includes the subject matter of Example 29, and optionally, comprising one or more antennas connected to the radio, and a processor to execute instructions of an operating system.

Example 31 comprises a wireless communication device comprising the apparatus of any of Examples 1-30.

Example 32 comprises a mobile device comprising the apparatus of any of Examples 1-30.

Example 33 comprises an apparatus comprising means for executing any of the described operations of any of Examples 1-30.

Example 34 comprises a product comprising one or more tangible computer-readable non-transitory storage media comprising instructions operable to, when executed by at least one processor, enable the at least one processor to cause a wireless communication device to perform any of the described operations of any of Examples 1-30.

Example 35 comprises an apparatus comprising: a memory interface; and processing circuitry configured to: perform any of the described operations of any of Examples 1-30.

Example 36 comprises a method comprising any of the described operations of any of Examples 1-30.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause an Access Point (AP) to:
identify a Trigger-Based (TB) sensing measurement exchange of a Wireless Local Area Network (WLAN) sensing procedure to be initiated by the AP; and
based on a determination that a non-AP Multi-Link Device (MLD) at an Enhanced Multi-Link Single Radio (EMLSR) operation mode is to participate as a sensing responder of the TB sensing measurement exchange, transmit an Initial Control Frame (ICF) addressed to the non-AP MLD prior to initiating the TB sensing measurement exchange.

2. The apparatus of claim 1 configured to cause the AP to transmit the ICF addressed to the non-AP MLD over a link between the AP and the non-AP MLD, which is to be used for the TB sensing measurement exchange.

3. The apparatus of claim 1, wherein the ICF comprises a trigger frame.

4. The apparatus of claim 1, wherein the ICF comprises a Multi-User Request to Send (MU-RTS) trigger frame or a Buffer Status Report Poll (BSRP) trigger frame.

5. The apparatus of claim 1, wherein the TB sensing measurement exchange comprises communication of at least one sounding Null Data Physical layer protocol data unit (NDP) between the AP and one or more sensing responders of the TB sensing measurement exchange.

6. The apparatus of claim 1 comprising at least one radio to transmit the ICF from the AP.

7. The apparatus of claim 6 comprising one or more antennas connected to the radio, and a processor to execute instructions of an operating system.

8. A product comprising one or more tangible computer-readable non-transitory storage media comprising instructions operable to, when executed by at least one processor, enable the at least one processor to cause an Access Point (AP) to:
identify a Trigger-Based (TB) sensing measurement exchange of a Wireless Local Area Network (WLAN) sensing procedure to be initiated by the AP; and
based on a determination that a non-AP Multi-Link Device (MLD) at an Enhanced Multi-Link Single Radio (EMLSR) operation mode is to participate as a sensing responder of the TB sensing measurement exchange, transmit an Initial Control Frame (ICF) addressed to the non-AP MLD prior to initiating the TB sensing measurement exchange.

9. The product of claim 8, wherein the instructions, when executed, cause the AP to transmit the ICF addressed to the non-AP MLD over a link between the AP and the non-AP MLD, which is to be used for the TB sensing measurement exchange.

10. An apparatus comprising logic and circuitry configured to cause an Access Point (AP) to:
mandate the AP to perform a polling phase at a beginning of a Trigger-Based (TB) sensing measurement exchange of a Wireless Local Area Network (WLAN) sensing procedure, based on a determination that a non-AP Multi-Link Device (MLD) at an Enhanced Multi-Link Single Radio (EMLSR) operation mode is to participate as a sensing responder of the TB sensing measurement exchange; and
transmit a sensing polling trigger frame to initiate the polling phase of the TB sensing measurement exchange.

11. The apparatus of claim 10 configured to cause the AP to, based on a determination that the non-AP MLD is capable of operating at the EMLSR operation mode, assign a non-AP station (STA) of the non-AP MLD to be polled in the TB sensing measurement exchange.

12. The apparatus of claim 10 configured to cause the AP to, based on a determination that the non-AP MLD is capable of operating at the EMLSR operation mode, transmit to a non-AP station (STA) of the non-AP MLD an indication that the non-AP STA of the non-AP MLD is assigned to be polled in the TB sensing measurement exchange.

13. The apparatus of claim 10 configured to cause the AP to set a poll-assigned field to “1” in a TB specific element in a sensing measurement request frame addressed to a non-AP station (STA) of the non-AP MLD, based on a determination that the non-AP MLD is capable of operating at the EMLSR operation mode.

14. The apparatus of claim 10 configured to cause the AP to transmit the sensing polling trigger frame according to a transmit configuration of an Initial Control Frame (ICF) defined for the EMLSR operation mode.

15. The apparatus of claim 10 configured to cause the AP to transmit the sensing polling trigger frame in a non-High-Throughput (non-HT) Physical Layer Protocol Data Unit (PPDU) or a non-HT duplicate PPDU format.

16. The apparatus of claim 10 configured to cause the AP to transmit the sensing polling trigger frame at a data rate of 6 Megabits per second (Mb/s), 12 Mb/s, or 24 Mb/s.

17. The apparatus of claim 10 configured to cause the AP to start with a polling phase any TB sensing measurement exchange involving at least one non-AP MLD at the EMLSR operation mode.

18. The apparatus of claim 10, wherein the TB sensing measurement exchange comprises communication of at least one sounding Null Data Physical layer protocol data unit (NDP) between the AP and one or more sensing responders of the TB sensing measurement exchange.

19. The apparatus of claim 10 comprising at least one radio to transmit the sensing polling trigger frame from the AP.

20. The apparatus of claim 19 comprising one or more antennas connected to the radio, and a processor to execute instructions of an operating system.
